(19) United States
(12) Patent Application Publication
(10) Pub. No.: US 2006/0242848 A1
(43) Pub. Date: Nov. 2, 2006

(54) Protective cover

(75) Inventor: Christine M. Ciccone, New Haven, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis (US)

(21) Appl. No.: 11/119,017

(22) Filed: Apr. 29, 2005

(51) Int. Cl. B26B 21/40

(52) U.S. Cl. 30/539

(57) ABSTRACT

A protective cover for a shaving razor is provided. The shaving razor comprises a razor cartridge releasably coupled to a handle. The razor cartridge includes one or more razor blades, each having a cutting edge. A shaving aid body may also be releasably coupled to the handle. The razor cartridge and shaving aid body may be releasable individually or as a unit. The handle has one or more user operable buttons to release the razor cartridge and shaving aid body when operated by the user. The protective cover has a top wall that covers the cutting edges of the blades and the top surface of the shaving aid body to protect these elements from accidental damage. The protective cover has a side surface that covers the user operable buttons to prevent these being operated by the user when the protective cover is coupled to the shaving razor.

### BACKGROUND OF THE INVENTION

1. Field of the Invention

The present invention relates to shaving razors in general and, more particularly, to protective covers for razors.

2. Detailed Description

Modern shaving razors include one or more blades disposed within a housing that is coupled to a handle. The housing and the blade or blades is referred to as a razor cartridge. Some handles are reusable and the razor cartridge is releasably coupled thereto and is intended to be disposed of after use. Further shaving razors of this type are additionally provided with an erodable shaving aid body that is further releasably coupled to the reusable handle and may be positioned adjacent to the razor cartridge as is disclosed in published U.S. patent application Ser. No. 10/367,255. This shaving aid body, being erodable in use, is also intended to be disposed of after it is exhausted. To enable the user to release a used razor cartridge and shaving aid body, in order to be able to replace one or both, the reusable handle is customarily provided with one or more user operable buttons. These buttons are linked to a mechanism, internally positioned in the reusable handle, which facilitates the coupling and release of the razor cartridge and shaving aid body to and from the handle. Recoupling of a new razor cartridge and shaving aid body is a somewhat complicated operation as both components have to be recoupled in the correct order and correct orientation and the elements for attachment of both to the reusable handle must be simultaneously correctly aligned to the handle. This operation is facilitated for the user by the manufacturer providing the razor cartridge and shaving aid body, correctly oriented and aligned, within a dispensing container. The user simply aligns the reusable handle to the mouth of the dispensing container and brings the reusable handle into contact with the exposed surfaces of the fresh razor cartridge and shaving aid body. The fresh razor cartridge and shaving aid body are coupled to the reusable handle and the user withdraws both, in unison, from the dispensing container.

Currently, the state of the art for these types of shaving razors is for the manufacturer to further provide a protective cover that is removably coupled to the handle. The protective cover protects the razor cartridge and, if provided, the shaving aid body from accidental damage if, for instance, the razor is dropped, or from contact with a foreign object. The protective cover may also protect the razor cartridge and shaving aid body during travel. The protective cover is customarily coupled to the handle by a press fit or removable snap fit.

When a new user is presented with a shaving razor as described previously and for example as disclosed in US Design Pat. No. D 495829 (to Dombrowski et al), the user sees a handle with exposed button or buttons and the outside shell of the protective cover as the protective cover encloses the releasable razor cartridge and, if provided, the shaving aid body. In order for the user to use the shaving razor for shaving, the user's first task is to successfully remove the protective cover. If the new user is unfamiliar with this type of razor, the user's first inclination might be to operate the buttons in a belief that these will release the protective cover. Unfortunately this action will only release the razor cartridge and shaving aid body from the handle, within the confines of the protective cover. As the razor cartridge and shaving aid body are not within their dispensing container, correctly recoupling these to the handle is a somewhat complicated operation.

In the prior art, US Design Pat. No. D 409797 (to Bone) discloses an electric dry shaver having a cover. The cover includes a single ear that houses a brush. When the cover is coupled to the razor the ear of the cover overlays the on/off switch of the razor and would prevent the user turning the razor on when the cover is coupled thereto. The razor has no obviously replaceable elements coupled thereto, and especially a razor cartridge and shaving aid body that might be released by this button and that might in turn be complicated to recouple.

In further prior art, Japanese Patent No 53-36359 (to Iwasaki et al) discloses another electric dry shaver having a cover and a sliding catch designated 8 in FIG. 3 thereof. In operation, the catch may be slid over a hook (designated 3 in FIG. 1 thereof) of the cover. With the catch slid to this position, the catch secures the cover to the razor and will further act as an interlock to prevent the on/off switch from being operated by the user. Again, the razor has no obviously replaceable elements coupled thereto, and especially a razor cartridge and shaving aid body that might be released by this button and that might in turn be complicated to recouple. Furthermore, the catch may be slid to the interlock position independently of the cover being coupled to the razor. The cover with the hook plays no part in the interlocking function.

Therefore, there is a need in the art to provide a protective cover for a razor that covers or otherwise interlocks the release buttons of the handle to prevent operation of the release buttons by the user to release the razor cartridge when the protective cover is coupled to the handle.

### SUMMARY OF THE INVENTION

The protective cover of the present invention comprises a top wall and a side wall. The protective cover is removably coupled to a shaving razor comprising a handle and a razor cartridge. The razor cartridge is releasably coupled to the handle. The razor cartridge comprises one or more razor blades, each razor blade having a cutting edge. The handle has one or more user operable buttons that release the razor cartridge from the handle when operated by the user. When the protective cover is coupled to the shaving razor the top wall of the protective cover substantially overlays the cutting edges of the razor blades to protect the cutting edges from accidental damage. Further, when the protective cover is coupled to the shaving razor the side wall of the protective cover overlays at least one of the user operable buttons to prevent operation of the button by the user.

In a further aspect of the present invention, the shaving razor further comprises an erodable shaving aid body. The shaving aid body is preferably coupled to the razor cartridge and the shaving aid body and razor cartridge are releasable from the handle as a single unit. The shaving aid body has an upper surface and the top wall of the protective cover substantially overlays the cutting edges of the razor blades and the upper surface of the shaving aid body to protect either or both from accidental damage. Further, when the protective cover is coupled to the shaving razor the side wall of the protective cover overlays at least one of the user operable buttons to prevent operation of the button by the user.

In a further aspect of the present invention, the side wall of the protective cover is shaped so that the protective cover can be coupled to the shaving razor in one orientation only.

In a further aspect of the present invention, the side wall and the top wall of the protective cover have inner surfaces that are contiguous to form a cavity. The inner surface of the side wall has one or more ribs, each rib having an end surface. The end surfaces abut the handle when the protective cover is coupled to the handle to space the top wall away from the upper surface of the shaving aid body and the cutting edges of the razor blades.

In a further aspect of the present invention, the protective cover is provided with one or more drain ports. The drain ports permit liquid trapped within the protective cover to drain out when the shaving razor is hung upside down or at rest on a horizontal surface.

In a further aspect of the present invention, the protective cover is coupled to the shaving razor by a snap fit or by a press fit.

In a further aspect of the present invention, the protective cover is a molded thermoplastic.

In a further aspect of the present invention, the release buttons of the handle must be operated in unison to release the razor cartridge.

The above features and advantages of the present invention will be more fully understood with reference to the following detailed description when taken in conjunction with the accompanying drawings.

### BRIEF DESCRIPTION OF THE DRAWINGS

FIG. 1 is an isometric view from the front and top of the protective cover of the present invention coupled to a shaving razor.

FIG. 2 is a side view of the protective cover of the present invention coupled to a shaving razor.

FIG. 3 is a front view of the protective cover of the present invention coupled to a shaving razor.

FIG. 3A is a detailed view of FIG. 4.

FIG. 4 is a sectional view along line 4-4 of FIG. 3.

FIG. 5 is a detailed view of FIG. 4.

FIG. 6 is an isometric view from below of the protective cover of the present invention.

FIG. 7 is a front view of the protective cover of the present invention.

FIG. 8 is an underside view of the protective cover of the present invention.

FIG. 9 is a side view of the protective cover of the present invention.

### DETAILED DESCRIPTION OF THE PREFERRED EMBODIMENT

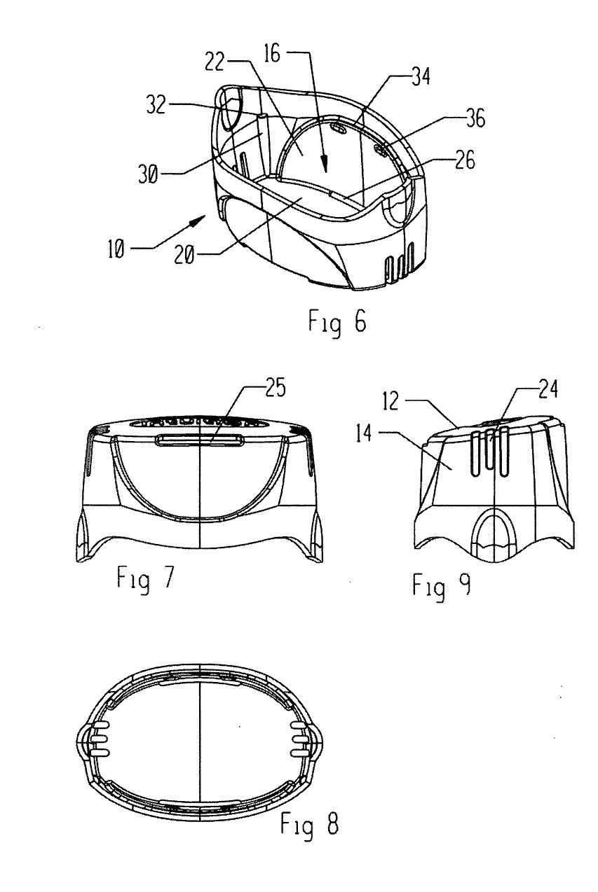

Referring now to the drawings and in particular FIGS. 6-9, a protective cover 10 for a shaving razor is shown. The protective cover comprises a top wall 12 and a side wall 14. The top wall has an inside surface 20 and the side wall has an inside surface 22, the inside surfaces being contiguous to form a cavity 16. The protective cover is preferably an injection molded thermoplastic, more preferably a commodity thermoplastic and even more preferably polypropylene. A suitable polypropylene is manufactured by Basell and designated Moplen RP344R. One of skill in the art will recognize that other materials are suitable for the present invention.

The protective cover is provided with drain ports 24 at each lengthwise end of the top wall of the protective cover. The protective cover is further provided with a drain port 25 at the front of the protective cover and a drain port 26 at the rear thereof. The drain ports are preferably positioned to permit any liquid trapped within the protective cover to drain out when the protective cover is coupled to a shaving razor and when the shaving razor with coupled protective cover is hung upside down or laid on a horizontal surface in a stable at-rest orientation.

Referring in particular to FIG. 6, the protective cover has a rib 30 extending partially along the inside surface of the side wall. The rib has end surface 32 that acts as a primary abutting surface. The protective cover also has a secondary abutting surface 34. The protective cover has one or more snap-fit teeth 36.

Referring in particular to FIG. 8 it can be seen that the protective cover is asymmetrically shaped relative to any horizontal axis relative to the printed page that may be defined in this figure. The asymmetric shape permits the protective cover to be coupled to the shaving razor in one orientation only.

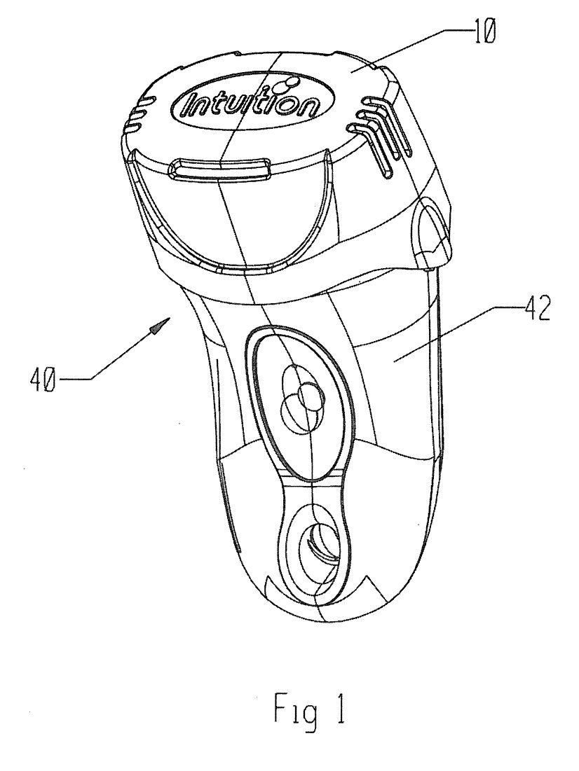

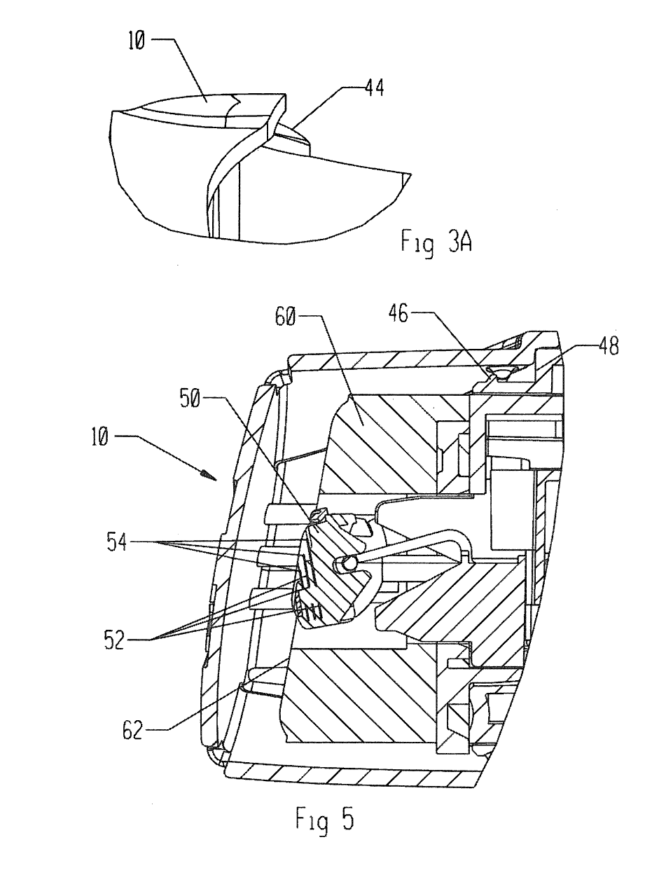

Referring now to FIGS. 1-5, a protective cover coupled to a shaving razor 40 is shown. The shaving razor comprises a handle 42, a razor cartridge 50 and a shaving aid body 60. The razor cartridge comprises razor blades 52 having cutting edges 54. The shaving aid body has an upper surface 62. The handle has one or more user operable buttons 44. The function of the buttons is to release the razor cartridge when operated by the user. Where two or more buttons are provided it is preferable that the two or more buttons be operated in unison to release the razor cartridge. In the preferred embodiment the buttons release the razor cartridge and shaving aid body in unison. One of skill in the art will understand it is possible for the buttons to release these elements individually or for one element to be manually releasable, that is, it can be released by hand without use of a button. Referring in particular to FIG. 5, the top wall of the protective cover overlays the cutting edges of the razor blades and the upper surface of the shaving aid body with the inside surface of the top wall spaced apart therefrom. A snap-fit tooth of the protective cover engages mating feature 46 of the handle. One of skill in the art will understand that other methods, such as a press fit, are also suitable to couple the protective cover to the shaving razor. The secondary abutting surface 34 of the protective cover abuts a surface 48 of the handle to space the inside surface of the top wall away from the cutting edges of the razor blades and the upper surface of the shaving aid body. The primary abutting surface 32 simultaneously abuts another surface of the handle. This condition is not shown in the drawings but would be obvious to one of skill in the art.

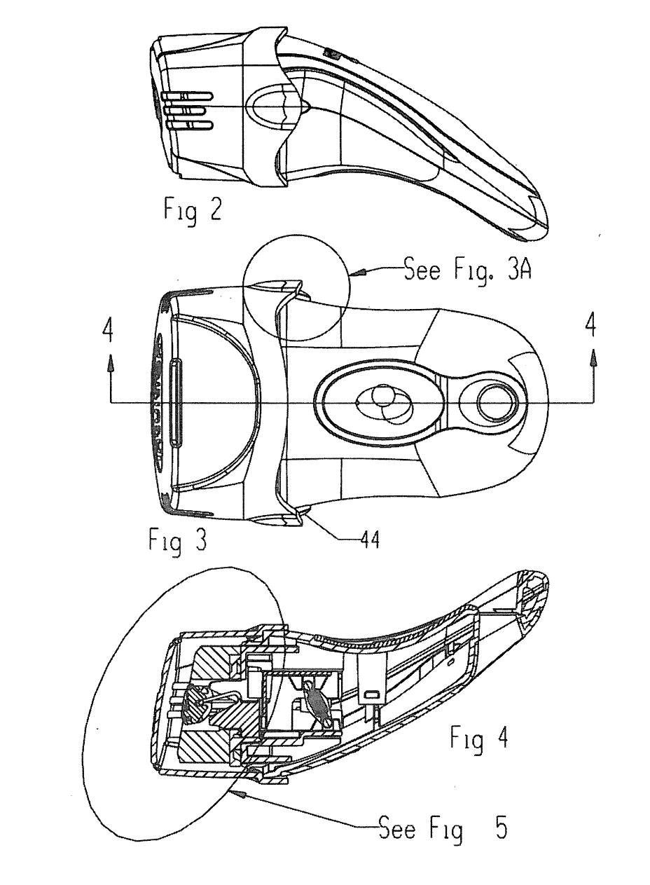

Referring in particular to FIGS. 2, 3 and 3A, the side wall 14 of the protective cover 10 partially overlays the buttons 44 of the handle. This will prevent the user from operating the buttons when the protective cover is coupled to the shaving razor. One of skill in the art will understand that it is not necessary for the side wall to overlay all of the buttons where two or more buttons are provided. Where two or more buttons must be operated in unison, prevention of function of one button will have the same effect as prevention of function of all buttons. One of skill in the art will furthermore understand that it is not necessary for the side wall to completely overlay the buttons. It is merely necessary to prevent operation of the buttons. The side wall may be spaced away from the button so as to prevent a user's finger from entering the gap and operating the button. Alternatively the side wall may closely overlay at least a part of the button or be in contact with a part of the button to restrict its movement so that it is unable to function.

It is to be understood that the present invention is by no means limited to the particular construction herein disclosed and/or shown in the drawings, but also comprises any modifications or equivalents within the scope of the disclosure.

What is claimed is:

1. A protective cover for a razor, the protective cover comprising:
a top wall and a side wall,
wherein the protective cover is removably coupled to a shaving razor,
the shaving razor comprising a handle and a razor cartridge, wherein the razor cartridge is releasably coupled to the handle, wherein the razor cartridge comprises one or more razor blades, each razor blade having a cutting edge,
wherein the handle has a first set of one or more user operable buttons that release the razor cartridge from the handle when operated by the user,
wherein the top wall of the protective cover substantially overlays the cutting edges of the razor blades,
and wherein the side wall of the protective cover overlays at least one of the user operable buttons to prevent operation of the button by the user when the protective cover is coupled to the shaving razor.

2. A protective cover according to claim 1 wherein the shaving razor further comprises a shaving aid body having an upper surface wherein the shaving aid body is releasably coupled to the handle and wherein the top wall of the protective cover substantially overlays the upper surface.

3. A protective cover according to claim 2 wherein the razor cartridge and shaving aid body are releasably coupled to the handle as a single unit.

4. A protective cover according to claim 3 wherein the side wall of the protective cover is shaped to be removably couplable to the shaving razor in a single orientation only.

5. A protective cover according to claim 4 wherein the protective cover has one or more drain ports.

6. A protective cover according to claim 5 wherein the top wall has an inner surface and the side wall has an inner surface, the inner surfaces of the top wall and the side wall being contiguous to form a cavity, the protective cover further comprises one or more ribs that extend along at least a part of the inside surface of the side wall, wherein the rib has an end surface and wherein the end surface of the rib abuts the handle when the protective cover is coupled to the shaving razor to space the top wall away from the upper surface of the shaving aid body and the cutting edges of the razor blades.

7. A protective cover according to claim 6 wherein the protective cover is a molded thermoplastic.

8. A protective cover according to claim 7 wherein the protective cover is removably coupled to the shaving razor by one or more snap-fits.

9. A protective cover according to claim 7 wherein the protective cover is removably coupled to the shaving razor by a press fit.

10. A protective cover according to claim 3 wherein the first set of one or more user operable buttons must be operated in unison to release the razor cartridge and shaving aid body as a single unit.

11. A protective cover according to claim 2 wherein the side wall of the protective cover is shaped to be removably couplable to the shaving razor in a single orientation only.

12. A protective cover according to claim 11 wherein the protective cover has one or more drain ports.

13. A protective cover according to claim 12 wherein the top wall has an inner surface and the side wall has an inner surface, the inner surfaces of the top wall and the side wall being contiguous to form a cavity, the protective cover further comprises one or more ribs that extend along at least a part of the inside surface of the side wall, wherein the rib has an end surface and wherein the end surface of the rib abuts the handle when the protective cover is coupled to the shaving razor to space the top wall away from the upper surface of the shaving aid body and the cutting edges of the razor blades.

14. A protective cover according to claim 13 wherein the protective cover is a molded thermoplastic.

15. A protective cover according to claim 14 wherein the protective cover is removably coupled to the shaving razor by one or more snap-fits.

16. A protective cover according to claim 15 wherein the protective cover is removably coupled to the shaving razor by a press fit.

17. A protective cover according to claim 15 wherein the first set of one or more user operable buttons must be operated in unison to release the razor cartridge.

18. A protective cover according to claim 2 wherein the handle further comprises a second set of one or more user operable buttons that release the shaving aid body from the handle when operated by the user.

19. A protective cover according to claim 18 wherein the second set of one or more user operable buttons must be operated in unison to release the shaving aid body.
